(19) United States
(12) Patent Application Publication
(10) Pub. No.: US 2016/0348825 A1
(43) Pub. Date: Dec. 1, 2016

(54) BURST-PROOF WATER PIPE ADAPTER

(71) Applicant: DJ-Hose Co., LTD., Kaiping City (CN)

(72) Inventor: QINGQING LIU, Kaiping City (CN)

(21) Appl. No.: 14/926,621

(22) Filed: Oct. 29, 2015

(30) Foreign Application Priority Data
May 29, 2015 (CN) 201520360366.X

(51) Int. Cl. F16L 55/10; F16K 15/02

(52) U.S. Cl. CPC F16L 55/1022; F16K 15/025

(57) ABSTRACT

The invention discloses a burst-proof adapter, which is installed on a water pipe so that the usual water pipe is constructed as an anti-burst hose. Wherein one end of the adapter is connected with the usual water pipe through a base, and the other end of the adapter is connected with water source such as a water tap by a screw nut. The adapter is arranged within the nut at the water inlet, and comprises an inner core, a spring and a housing. The inner core is used for blocking a water outlet and cutting off the water flow when the water pipe bursts; the spring is used for supporting the inner core and preventing the water inlet from being blocked by the inner core in a situation of no burst of the water pipe; and the housing is used for adjusting water entry pressure, supporting the inner core, and fixing the spring and the inner core. The invention can effectively prevent water pipes from bursting and spraying water, and can be widely used in outdoors or indoors situations such as home, school, factory, warehouse and office building.

### FIELD OF THE INVENTION

The present invention relates to an adapter for water pipe, especially to an adapter for the pipe capable of effectively preventing water pipes from bursting and spraying water.

### BACKGROUND OF THE INVENTION

At present, the function of the commercially available water pipes is only for guiding water flow, but typically doesn't include a burst-proof function. Moreover, the quality of pipes is not stable. Even though the water pipes are good enough in quality, the probability of bursting of water pipes is still exist because of uncertain external factors such as environment, time, etc., resulting in spraying water to the surrounding, thereby causing flooding and personal and property damages. Although, the similar burst-proof devices for preventing the water pipes from bursting are commercially available, they are complex in structure, uneconomic in material, unsatisfactory in effects for burst-proof, and inconvenient in installation and use.

### SUMMARY OF THE INVENTION

The invention aims to provide a burst-proof adapter, to overcome the defects that the existing water pipe products do not have the function of burst-proof and the existing burst-proof device for preventing the water pipes from bursting have poor effective of burst-proof, to thereby effectively prevent water pipes from bursting and spraying water, and to avoid flooding, and personal property damages.

The invention is realized in that: a burst-proof adapter according to the invention comprises a inner core, a spring and a housing; the inner core is used for blocking a water outlet and cutting off the water flow when the water pipe bursts; the spring is used for supporting the inner core and preventing the water inlet from being blocked by the inner core in a situation of no burst of the water pipe; and the housing is used for adjusting water entry pressure, supporting the inner core, and fixing the spring and the inner core.

Further, an additional sealing ring may be preferably provided between the housing and the base.

The invention has reasonable design, compact structure, easy installation, convenient use, and security and reliability. The invention can effectively prevent water pipes from bursting and spraying water, and can be widely used in outdoors or indoors such as home, school, factory, warehouse and office building.

### BRIEF DESCRIPTION OF THE DRAWINGS

FIG. 1 is a structural schematic diagram according to the invention, in which the reference numerals are listed as follows: 1. housing; 2. inner core; 3. spring; 4. seal ring; 5. base.

### DETAILED DESCRIPTION OF THE EMBODIMENTS

The structure of the invention is further described below with reference to the drawings and the embodiments.

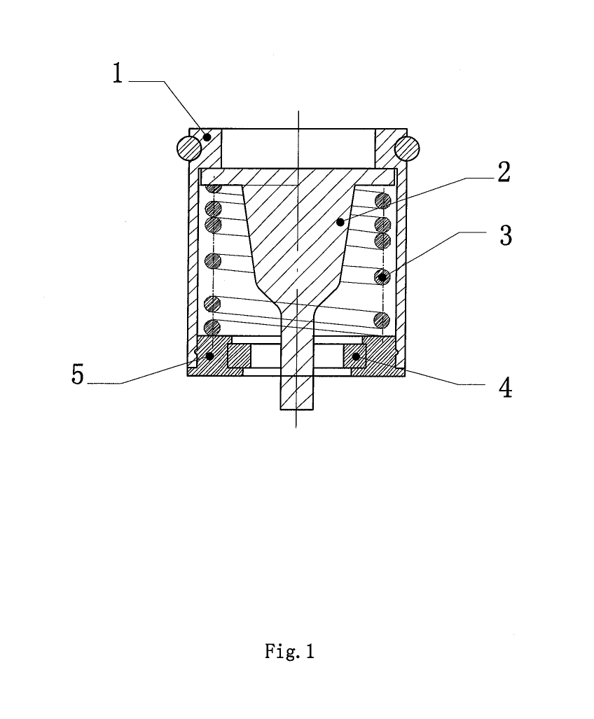

A burst-proof adapter according to the invention is installed on a water pipe so that the usual water pipe is constructed as an anti-burst water pipe, as shown in the FIG. 1. Wherein one end of the burst-proof adapter is connected with the usual water pipe through a base 5, and the other end of the burst-proof water pipe adapter is connected with water source such as a water tap by a screw nut.

The burst-proof adapter is arranged within the nut at the water inlet, and comprises an inner core 2, a spring 3 and a housing 1. The inner core 2 is used for blocking a water outlet and cutting off the water flow when the water pipe bursts. The spring 3 is used for supporting the inner core 2 and preventing the water inlet from being blocked by the inner core 2 in a situation of no burst of the water pipe. The housing 1 is used for adjusting water entry pressure, supporting the inner core 2, and fixing the spring 3 and the inner core 2.

Alternatively, an additional sealing ring 4 may be preferably provided between the housing 1 and the base 5.

The burst-proof adapter is designed based on the operating principle of the change of pressure difference at upper and lower connection pipes near the adapter before and after the water pipe bursts. When the water flow passes through the adapter, the water pressure before the water pipe bursts is small, the spring 3 is in a released state, so that the inner core 2 is held stable in place, and the water flow passes into the water pipe via a hole of the housing 1 and flows to the water outlet. After the water pipe bursts, the water pressure of the water flow passing through the adapter increases, so that the bigger water pressure drives the inner core 2 move towards the water outlet and block the water outlet, therefore water spraying due to the burst of the water pipe can be avoided, and damages of flooding can be avoided.

The above are only preferred embodiments of the invention. It should be noted that many variations and improvements can be made by those skilled in the art without departing from the principles of the invention, and should fall into the scope of protection of the invention.

1. A burst-proof adapter, characterized in that: the adapter comprises an inner core (2), a spring (3) and a housing (1); the inner core (2) is used for blocking a water outlet and cutting off the water flow when the water pipe bursts; the spring (3) is used for supporting the inner core (2) and preventing the water inlet from being blocked by the inner core (2) in a situation of no burst of the water pipe; and the housing (1) is used for adjusting water entry pressure, supporting the inner core (2), and fixing the spring (3) and the inner core (2).

2. The burst-proof adapter according to claim 1, characterized in that an additional sealing ring may be provided between the housing (1) and the base (5).
